(19) United States
(12) Patent Application Publication
(10) Pub. No.: US 2020/0118086 A1
(43) Pub. Date: Apr. 16, 2020

(54) SMART CONTRACTS WITHIN A BLOCKCHAIN SYSTEM TO DYNAMICALLY AND AUTOMATICALLY MANAGE A REPLACEMENT PROCESS

(71) Applicant: Cisco Technology, Inc., San Jose, CA (US)

(72) Inventor: Brice Achkir, Livermore, CA (US)

(21) Appl. No.: 16/156,961

(22) Filed: Oct. 10, 2018

(51) Int. Cl. G06Q 10/00; H04L 29/06; G06Q 10/06; G06Q 20/10; G06Q 10/08

(52) U.S. Cl. CPC G06Q 10/20; H04L 63/105; G06Q 10/083; G06Q 10/06316; G06Q 20/10; H04L 63/104

(57) ABSTRACT

Systems, methods, computer-readable media, and devices are disclosed for managing a replacement process. A request is received from a user to perform maintenance on a product. An event based on node supply chain relationships specified within a smart contract is created in accordance with a rule or policy of the smart contract. The event, which is based on at least one condition that is in accordance with fulfilling the rule or policy of the smart contract, is sent to a node on a distributed network, where the node is configured to automatically execute the condition. Decentralized status information for the product is updated when the event has been fulfilled, and read access to the decentralized status information of the product is granted to at least one node on the distributed network.

### TECHNICAL FIELD

The present disclosure relates generally to product maintenance using a supply chain, and more specifically to real time updates and replacement functionality for products within the supply chain.

### BACKGROUND

Supply chain networks around business transactions tend to be complex, as the supply chain networks are designed to address a multitude of business activities between disparate partners or suppliers. For example, supply chain network complexities arise due to the need to customize for new needs, implement management rapidly, deal with sensitive data sharing and other security concerns, etc. Moreover, these complexities arise in addition to the supply chain network's high cost associated with recurring licensing fees, extensive resource trainings, and lack of interconnectivity between different systems within the supply chain network.

A typical supply chain network for a large company needs to deal with potentially thousands of nodes of suppliers and partners, the number of which may increase or decrease dynamically as different suppliers or partners are brought in or leave the system. These suppliers and partners are partially managed through disparate in-house systems, human beings, meetings, calls, etc. Communications between different suppliers on the supply chain network are done through direct communication between themselves, such as through business to business (B2B) messages.

However, information can be lost through B2B messages, and can be prone to error or, at best, slow. This is especially harmful for processes that require quick turn around, such as expedited replacements of products. A more timely, accurate, and flexible supply chain system is needed.

### BRIEF DESCRIPTION OF THE DRAWINGS

The above-recited and other advantages and features of the present technology will become apparent by reference to specific implementations illustrated in the appended drawings. A person of ordinary skill in the art will understand that these drawings only show some examples of the present technology and would not limit the scope of the present technology to these examples. Furthermore, the skilled artisan will appreciate the principles of the present technology as described and explained with additional specificity and detail through the use of the accompanying drawings in which:

FIG. 1 shows an example schematic diagram of a supply chain network that includes various nodes that are configured to maintain a blockchain in accordance with some embodiments;

FIG. 2 is a flowchart representation of an example implementation of a supply chain in a blockchain environment in accordance with some embodiments;

FIG. 3 shows a diagram of an example supply chain process for a product in accordance with some embodiments;

FIG. 4 shows a diagram of an example build and shipping process for a replacement product in accordance with some embodiments;

FIG. 5 shows a block diagram of an example implementation of a blockchain in accordance with some embodiments;

FIG. 6 is a flowchart representation of providing access permissions in a blockchain environment in accordance with some embodiments;

FIG. 7 shows an example schematic diagram of a blockchain network that provides data visualization and analytics in accordance with some embodiments; and

FIG. 8 shows an example of a system for implementing certain aspects of the present technology.

### DESCRIPTION OF EXAMPLE EMBODIMENTS

Various examples of the present technology are discussed in detail below. While specific implementations are discussed, it should be understood that this is done for illustration purposes only. A person skilled in the relevant art will recognize that other components and configurations may be used without parting from the spirit and scope of the present technology.

### Overview:

Systems, methods, computer-readable media, and devices are disclosed for managing a replacement process. A request is received from a user to perform maintenance on a product. An event based on node supply chain relationships specified within a smart contract is created in accordance with a rule or policy of the smart contract. The event, which is based on at least one condition that is in accordance with fulfilling the rule or policy of the smart contract, is sent to a node on a distributed network, where the node is configured to automatically execute the condition. Decentralized status information for the product is updated when the event has been fulfilled, and read access to the decentralized status information of the product is granted to at least one node on the distributed network.

### Example Embodiments

The disclosed technology addresses the need in the art for providing systems and methods for products that may need maintenance or replacement. This innovation uses smart contracts within a blockchain system to dynamically and automatically manage the replacement process in an easy, decentralized way. Smart contracts can digitize complex business logic (rules and policies) and automate them to self-execute when conditions are met. Since a typical supply chain network for a large company needs to deal with potentially thousands of nodes of suppliers and partners, the number of which may increase or decrease dynamically as different suppliers or partners are brought in or leave the system, the odds of a mistake or failure in B2B messages increase even as client expectations and need for prompt replacement of faulty products increases. Self-executing business rules and policies are accordingly needed to avoid the shortcomings of B2B messages.

B2B messages can be vehicles to communicate, but they are slow and prone to error. Even if a company acts as a centralizing party by hosting the supply chain network that gets and sends B2B messages to and from all the parties involved, errors can be inadvertently inserted in these point to point transactions through transcription error or can be lost entirely. For example, large amounts of information exchanged between parties are not documented in any tool or supply chain network service, such as information exchanged during in-person meetings or phone calls. Moreover, even in the absence of error or the failure to input information, parties who engage in many meetings and phone calls find it laborious to add this information to the supply chain network and then determine which other parties should be able to see or access this information. All of these issues can lead to large errors or small errors that, in the aggregate, lead to large workflow issues that are costly, time consuming, or both.

In addition, with B2B messages, reliance is placed on a large number of parties. For example, it is up to the partner that can exchange the goods for replacement to separately deal with the carrier used to ship the replacement goods to the client's location through more B2B messages. The carrier, in turn, needs to prepare for any number of issues that arise from expedited shipping, including filling out forms for customs and initiating the shipping process among warehouses, trucks, and airlines. All this information needs to be shared between the carrier, partner, and/or client, but this process involves considerable amounts of information that are traded back and forth through B2B messages. The replacement process suffers from delays when there is a mistake or failure in any of the B2B messages, and also from lack of information when the carrier is visible to the partner but not visible to other parties (e.g., other partners or the client).

Moreover, not all devices or nodes of the supply chain network have B2B access, relying instead on traditional communications, such as calls, emails, etc. that never get reported to the supply chain network or a managing service/tool on the supply chain network.

Other issues, such as the visibility of the entire supply chain, are currently nonexistent, and the customer that requests maintenance for a product is unable to get a good idea of what is happening (such as when the product is expected to be replaced, where the replacement is coming from, where it is being shipped from, etc.).

These issues can be solved through a blockchain implementation of a replacement process. Blockchain implementations can be used to record the custody of a product (or parts of a product) for supply chain purposes. Various disclosed blockchain implementation examples can provide real time updates as the product is replaced or shipped across the world. Moreover, various blockchain implementation examples can also provide predictive implementations would allow a client to accurately plan around the replacement process.

For example, over time, systems and/or products may need maintenance or replacement. In these cases, it is imperative to deliver a replacement to the customer across the globe as quickly as possible. Due to the importance of a client's networking system to their business's operations, clients expect prompt replacement of failing network devices such that their business is not left without a working system for long. Moreover, many clients have specific service level agreements (SLAs) that require that their systems or products will be replaced within a short period of time (e.g., 4-24 hours). Replacement products, therefore, need to be shipped promptly and efficiently. But replacement information can be lost, for example, in any number of ways due to gaps in information and/or miscommunication, such as between different suppliers who are providing the replacement, or on flights that deliver the product. Moreover, the inability to determine when the product is replaced and/or delivered prevents payments between parties (e.g., suppliers, distributors, etc.) from being automated in an easy, decentralized way.

Accordingly, systems, methods, computer-readable media, and devices are disclosed for managing a more accurate and flexible replacement process. In examples, a request is received from a user to perform maintenance on a product. An event based on node supply chain relationships specified within a smart contract is created in accordance with a rule or policy of the smart contract. The event, which is based on at least one condition that is in accordance with fulfilling the rule or policy of the smart contract, is sent to a node on a distributed network, where the node is configured to automatically execute the condition. Decentralized status information for the product is updated when the event has been fulfilled, and read access to the decentralized status information of the product is granted to at least one node on the distributed network.

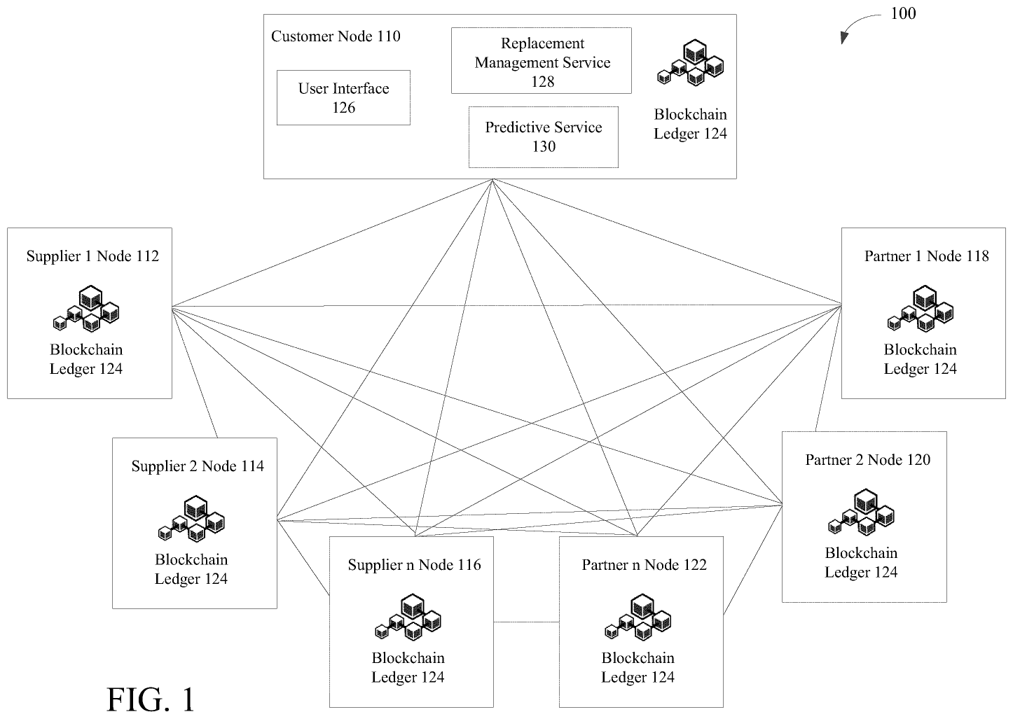

FIG. 1 shows an example schematic diagram of a supply chain network that includes various nodes that are configured to maintain a blockchain in accordance with some embodiments. Client node 110 is one of many nodes within the supply distribution chain network, system 100. Each node can be one or more of suppliers or partners in the supply distribution chain of the product. For example, system 100 can include any number of suppliers (e.g., vendor, plant, etc. involved with component storage, construction, assembly, merging of components, etc.) that have been enabled as nodes on system 100, such as supplier 1 node 112, supplier 2 node 114, . . . to supplier node n 116. System 100 can also include any number of partners as well (e.g., shippers, retailers, distributors, third party logistics providers, etc.), which have also been enabled as nodes: partner 1 node 118, partner 2 node 120 . . . to partner n node 122. Each node on system 100—including all suppliers, partners, and clients—include a copy of blockchain ledger 124 that has been duplicated across all the nodes.

Blockchain ledger 124 is any linked ledger system. In the embodiment shown, blockchain ledger 124 is a ledger system within a distributed blockchain, where a continuously growing list of records, called blocks, is linked to one or more previous blocks. Blocks can be continuously updated as blockchain ledger 124 is modified with subsequent events, transactions, data, updates, etc. from the nodes within system 100. For example, a block can receive a request from a user to perform maintenance on a product, such as through replacement of one or more product components or parts supplied by supplier 1 node 112. A later block can record that the replacement product component has been transferred to an airline for overseas shipment (e.g., partner 1 node 118), and another subsequent block can record that the replacement product component has been picked up by a carrier (e.g., partner 2 node 120) and is out for delivery. This record can extend throughout the entire maintenance or replacement of the associated product, including shipping an already stored replacement product or component or including the receipt of materials needed to manufacture a replacement of a faulty component not in storage (e.g., receiving, from an entity, product parts such as the wiring, transceiver parts, laser, etc. of a transceiver).

In the embodiment shown, system 100 can be used and run by one organization or entity, which can manage security and control authorization for each node on the network in addition to managing business rules and policies controlled by various smart contracts. For example, the organization may grant a first node access to only a portion of some data on the blockchain, so that information from another node (who may be a competitor of the first node) is kept private from the first node. The organization may even keep some information private from all network nodes. Alternatively, in some embodiments system 100 may be, in part or in whole, a public distributed blockchain. However, one of skill in the art will understand that any architecture that supports a chain of custody of individual components can be used to the same effect.

Each node can include functionality to read and/or access blockchain ledger 124, create events, record event completion or other transactions, data, updates, etc. A customer may also access blockchain ledger 124 at user interface 126 on customer node 110, subject to certain rules, policies, and restrictions set by replacement management service 128. Replacement management service 124 may include various smart contracts with various rules and policies that control the replacement process based on node supply chain relationships specified within the smart contract. Smart contracts can be versatile throughout the entire return process, and can be used for any condition based logic between the nodes, such as: automating payments, selecting nodes to handle portions of the return process, configuration of replacement products, etc. Smart contracts can automate these processes on demand in real- or near real-time.

For example, a smart contract may specify that the replacement of a faulty network device requires a replacement transceiver from supplier 1 node 112 and a replacement casing from supplier 2 node 114, that the order of replacement must happen for node 112 earlier than node 114, and that payment must be initiated to each of node 112 and node 114 once their roles are completed or delivered. In some examples, payment can be provided to nodes based on milestone events reached (e.g., a percentage based on completing a product or component, and the rest based on the user's receipt of the product or component within a set period of time(s)).

Moreover, a customer may be granted read access to all or a portion of the data on blockchain ledger 124 so that sensitive internal business data for, say, supplier 1, is not made public. This may be dictated by rules and/or polices within the smart contract(s). Any authorized party can write to blockchain ledger 124 of the present technology, but authorized parties can only read data on blockchain ledger 124 to which they have specific access.

Replacement management service 128 can also manage numerous functions of blockchain ledger 124, such as determining when and how to update blockchain ledger 124, whether to modify or create a block within blockchain ledger 124, initiate and/or customize events associated with product replacement or ordering within system 100, initiate or execute rules and policies within smart contracts, etc.

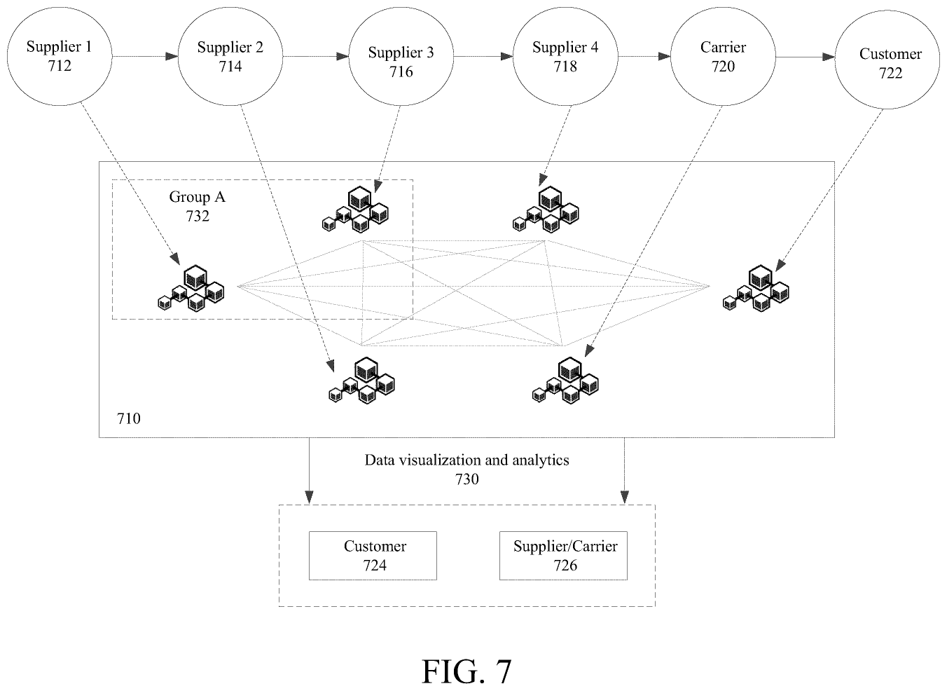

System 100 can also include predictive service 130, which can provide a prediction on how long it will take to replace the product, how long until the customer can expect the replacement to be delivered, and prediction adjustments based on component shortages or other delays (e.g., customs or shipment delays). Predictive service 130 is discussed in more detail in FIG. 7.

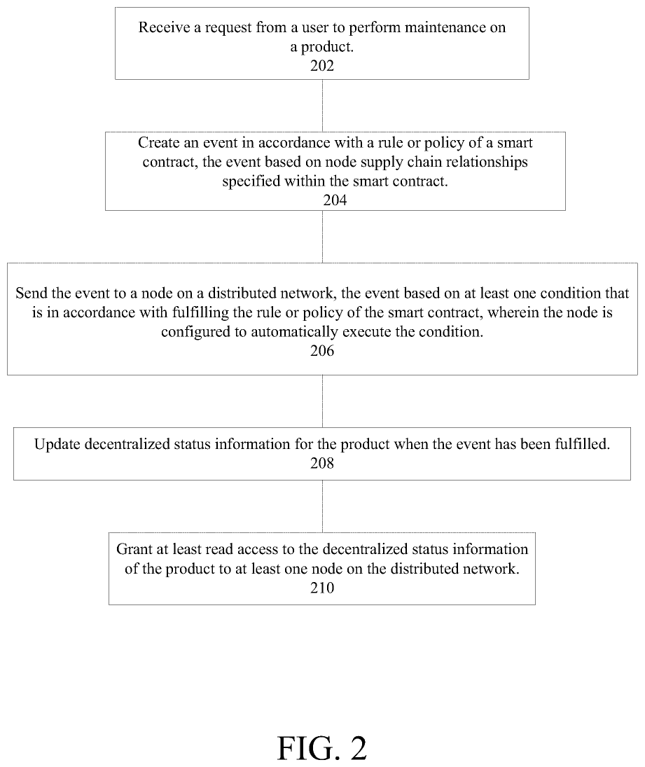

FIG. 2 is a flowchart representation of an example implementation of a supply chain in the blockchain environment in accordance with some embodiments. The method begins by receiving a request from a user to perform maintenance on a product (step 202). The request can be received, for example, through user interface 126 on customer node 110 and can include an option to ship a replacement of one or more products or components of a product. In some embodiments, the request can be for expedited product replacement based on a set period of time, such as a period of time agreed to in an SLA.

Once a client puts in a request, any node on the blockchain can view the request and inform the blockchain in real time that it has the replacement products available. The replacement products can be selected based on the ledger history, such as what products are parts of the system, how many times the product has been replaced in the past, why the product needs to be replaced, etc. The node can then reserve the replacement product within its inventory. Once the node indicates the replacement product is ready to ship (such as through the generation of an event), a smart contract can select one or more carriers based on that indication.

For example, the option for expedited shipping can enable the distributed network to automatically generate a set of tasks for the system's node(s) to replace the product based on at least one condition of a smart contract. An event, based on node supply chain relationships specified within the smart contract, can be created in accordance with one or more rules or policies of the smart contract (step 204). The event can be any action a node needs to execute to satisfy the conditions of the event (where the conditions are specified by one or more associated smart contracts). These can be real time updates for retrieving the product from storage, building the product, assembling the product, shipping the product, exchanging payments between one or more suppliers or partners, or a combination. For example, if the client request includes a system with a specific router that needs replacement, then the smart contract can automatically create an event, which Partner A can accept (or be assigned to). Once Partner A is designated to replace it, with the conditions that Partner A has a replacement of the specific router already in inventory or with the ability to manufacture the replacement within a specified period of time, then one or more events are associated with the node of Partner A on the distributed network. That node can automatically execute the conditions of the event in accordance with fulfilling the rules or policies of the smart contract (step 206). For example, Partner A can receive the event and, based on the event conditions, automatically put in a shipment order for the replacement product in its inventory (e.g., the specific router).

Decentralized status information can be updated for the product once the event has been fulfilled (step 208). The decentralized status information can include any information throughout the entire replacement process of the product, including replacements already in storage, and, if not already in storage, receipt of materials (e.g., receiving, from an entity, product parts such as the wiring, transceiver parts, laser, etc. of a transceiver) and manufacturing steps for a replacement product. The decentralized status information can also include shipping information and/or updates, such as delays in shipment or transfer between carriers. The decentralized status information can be received from one or more nodes on the distributed network, such as nodes 110, 112, 114, 116, 118, 120, and 122 that represent client, supplier, and/or partner nodes within the supply chain of the distributed network.

The user can then be granted access to the decentralized status information (step 210), such as read and/or write access to the decentralized status information of the product, although the access granted to the user can be subject to restrictions. Some of these restrictions can include granting the user read access to only a portion of the decentralized status information of the product to the user, but not access to the entire decentralized status information or no ability to write to blockchain ledger 124. The user can also be provided with a prediction of product build completion based on node supply chain relationships specified within one or more smart contracts and updates warning of delays (from shipping delays to manufacturing delays).

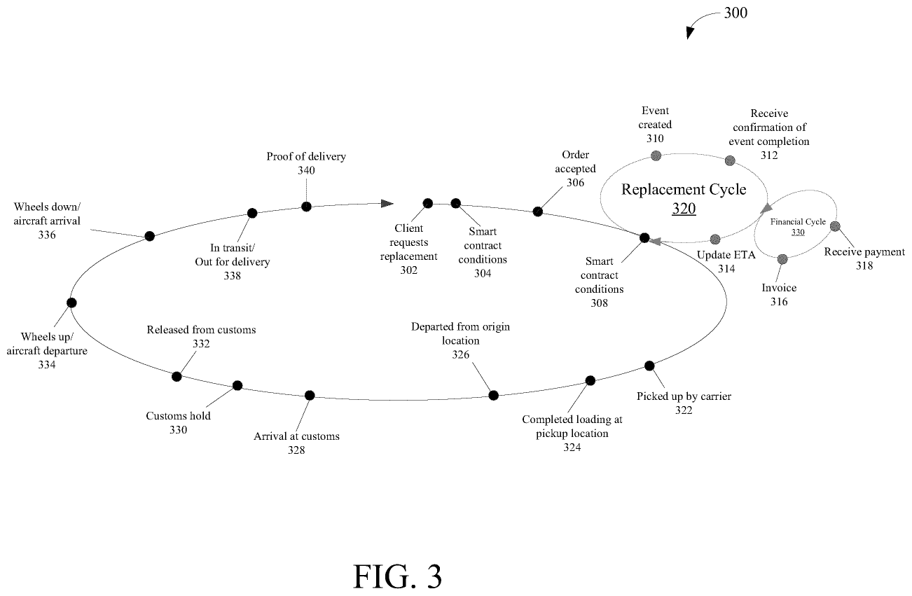

FIG. 3 shows a replacement process that utilizes the distributed network/blockchain for expedited returns according to various embodiments. The return process can be included in the distributed network for partial or complete read access by any client, partner, and/or carrier enabled as a node that, based on the event, automatically self-executes the conditions of the smart contract. This example embodiment illustrates an example supply chain 300 that can be used to process an expedited return request, from the initial replacement order of the product to the replacement product's final delivery. Many interdependencies are involved to make sure the request can be committed and then placed in queue for automatic execution, with each step in the process depending on information/data from the previous step in the sequential process. For example, events can be based on historical ledger history information. E.g., a smart contract can specify that an event can be generated 310 once the client request 302 and/or smart contract conditions 304 has been added to the blockchain. Each step can be used as status information that is added to a block within blockchain ledger 124 on the distributed network.

For example, the decentralized status information can include replacement cycle 320 to manage event creation based on smart contract conditions or logic. After the client's replacement order is accepted 206 by the blockchain, smart contract conditions 308 can be determined and used to automatically generate one or more events 310. Each event is sent to all nodes for completion, where nodes can accept the event or be assigned according to logic within smart contracts. Once completed, and confirmation of the completion is received 312 from an appropriate node, supply chain 300 can enter into financial cycle 330 and/or update the estimated time for arrival/completion of the replacement 314. Financial cycle 330 makes sure that nodes get paid once conditions associated with the event are satisfied. This can include the automatic generation of an invoice 316 for products or services rendered, and a confirmation that the node has received payment 318. The replacement cycle 320 can be repeated until a replacement is received by the user.

In some replacement processes, the replacement product may already be in storage. Thus, only events related toward shipping the replacement product out of a node's inventory are needed. However, in some instances the replacement product may not be in any node's inventory, and the replacement product will need to go through an expedited build process. Accordingly, the events can further encompass each step of the build process, and supply chain 300 can include updates to the build process itself once the events have been performed at the nodes. For example, the decentralized status information can include updates to order prioritization and/or backlog management as suppliers become available to provide the components, as well as the creation of the purchase request that is distributed to the nodes on the network once the order has progressed through a backlog queue. Events related to what components have been or are being produced can also be included in the decentralized status information, from the start of the build at a first site to the end of the build at another site. The decentralized status information can also include any testing of any components built throughout the build process.

Events related to the shipping process can also be included as decentralized status information. For example, blocks for the ledger can be created for the creation of shipping instructions and updates, such as the replacement product being picked up by a carrier 322, the completion of loading at a pickup location 324, the product departing from an origin location 326, the arrival and release from customs (328, 332), airline departure and arrival (334, 336), the product being out for delivery 338, and proof of delivery 340. While the events can process the shipment to customers (e.g., determining which airlines or carriers will deliver the product, and on which schedule), events can also provide updates on the performance of the shipment (e.g., whether there are any delays, such as those due to a customs hold 330 or due to weather/traffic that will affect the delivery date). The estimated time of arrival can be updated based on shipment performance being updated.

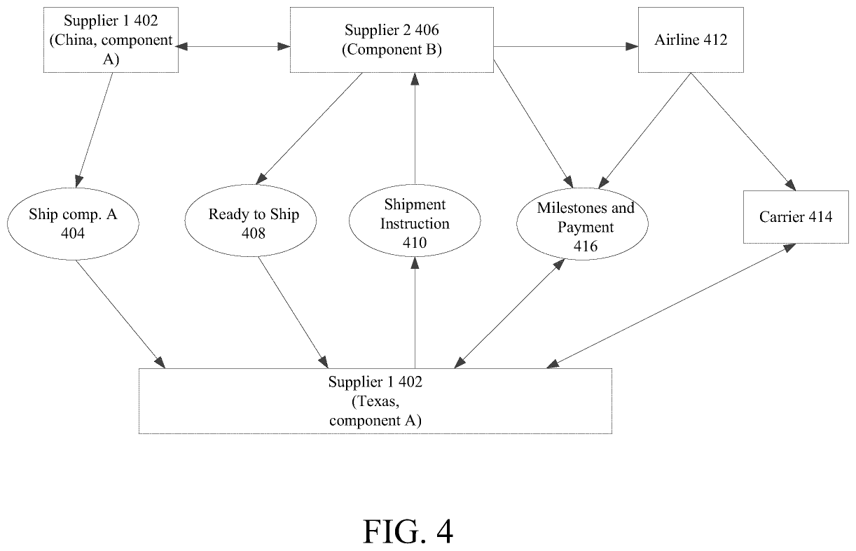

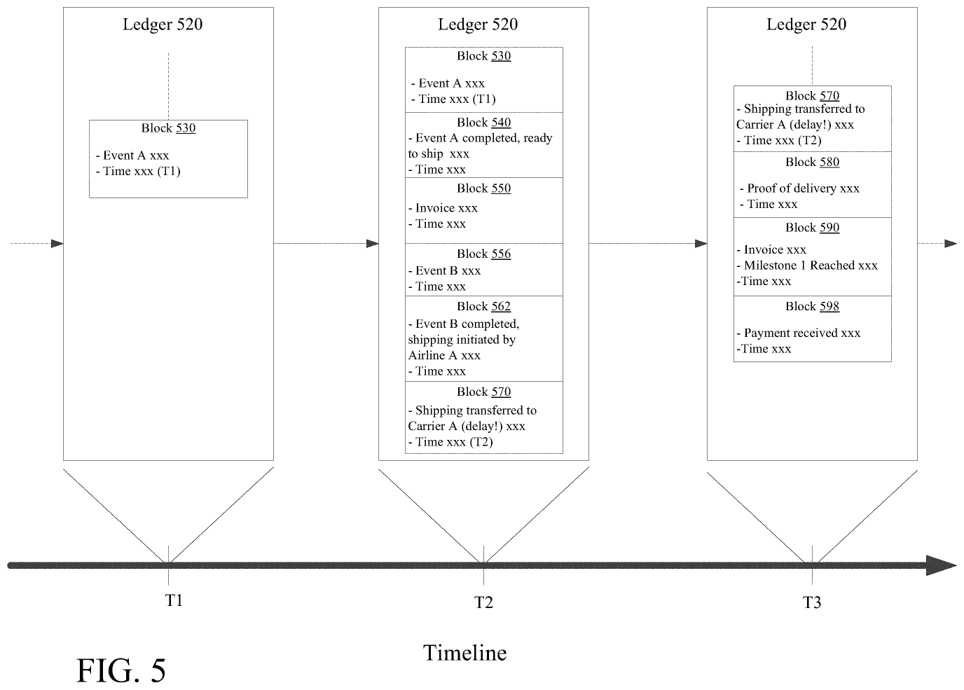

FIG. 4 shows a diagram of an example replacement process that includes building and shipping for a product that's not in inventory, in accordance with some embodiments, while FIG. 5 shows a block diagram of an example implementation of a blockchain showing block generation from FIG. 4's build and shipping replacement process. If a product is not available in any node's inventory, the product may include multiple components that require inbound logistics dealing with the shipment of those components making up the product in a replacement order. Supplier 1, for example, can start the partial build of a replacement in one site, but the smart contract overseeing the process may determine that it needs to go to a different site in a different location (e.g., different country) to finish. Moreover, the smart contract can determine that supplier 1 also needs to receive a component from supplier 2 before shipping the finished product to the customer.

So, in this example, the smart contract can determine that the finished replacement product includes components A and B. Supplier 1 can provide component A, but from different facilities. Specifically, a facility in China can provide a portion of component A (402) (e.g., a transceiver), but the rest of component A can only be provided by a facility in Texas (402) (e.g., a casing for the transceiver). Component B is to be provided by Supplier 2 (406). Thus, the final product needs to be built by coordinating, via events, between multiple suppliers with potentially multiple facilities across the world. Since supplier 1 (both facilities) and supplier 2 are enabled as nodes on the network, however, system 100 can handle this easily as described below.

System 100, based on a smart contract, can determine and then notify supplier 1 to manufacture component A (or supplier 1 can notify that it can supply component A). Since the smart contract has logic that determines component A has multiple parts that are manufactured at different nodes, the smart contract can automatically generate conditions that must be fulfilled between supplier 1, China 402 and supplier 1, Texas 402 in order to produce a completed component A. Similarly, blockchain ledger 124 can determine and then notify supplier 2 406 to manufacture component B. This can take the form of Event A (manufacturing component A) and event B (manufacturing component B). However, since supplier 1 402 has two different facilities that produce the completed component A, the events will coordinate, based on the conditions generated by the smart contract, between supplier 1's 402 facilities as well as supplier 2 406 to complete the final replacement product. Thus, once supplier 1 (China) completes component A, supplier 1 (China) can notify its other facility in Texas that component A has been shipped to it for completion (404). Once the Texas facility has completed component A, a notification of the completion of event A can be added to blockchain 520 at time T1 shown in FIG. 5, which illustrates ledger 520 at multiple times within the supply chain process.

Blockchain (ledger 520) is illustrated at times T1, T2, and T3, which are separated by time intervals. For example, ledger 520 includes a first block (block 530) at time T1, with block 560 appended to ledger 520 at T2, and block 580 appended to ledger 520 at T3. Each block can be appended at any time there is a step or event in the product's replacement timeline. Each block can also contain multiple events and/or transactions from multiple suppliers and/or partners. Thus, block 530 can be appended to ledger 520 once or after event A has been completed. For example, event A can specify that component A needs to be manufactured by supplier 1's China and Texas facilities. Accordingly, based on smart contract conditions and node supply relationships, event A 532 is generated in block 530 at time 534 (T1) that specifies that supplier 1, China 402 needs to manufacture a portion of component A, ship it to supplier 1, Texas 402, and then complete component A with supplier 1, Texas 402. Block 536 can add a notification to ledger 520 once event A has been completed and is ready to ship (538) at time 540. Block 542 can include an invoice 544 for products and/or services rendered at time 546.

Block 548 including event B 550 at time 552 can specify the manufacture or need for another component (component B) of the replacement product. For example, event B can specify that component B needs to be provided from inventory, if available, or manufactured if not. Once component B is completed by supplier 2 406, supplier 2 can inform all the nodes, including the client, that it is ready to ship (408). This can be done by, for example, supplier 2 406 adding block 554 to ledger 520 that component B is completed and ready to be shipped (556) at time 558. The smart contracts or supplier 2 406 can send shipment instructions 410 in block 554 at time 558 (e.g., through automatically providing an address or other shipping information) to Airline A.

Once block 554 is added to ledger 520, system 100 can contact airline 412 and/or carrier 414, and inform ledger 520 of the shipping request. Airline 412 or supplier 2 406 can inform ledger 520 that shipping has been initiated (556) at time 558. Any updates can be added to ledger 520 on a real time or near real time basis as decentralized status information, such as for a transfer in carriers (block 560), delivery of the product through proof of delivery 568 (block 566), delays in shipment due to custom holds, weather, time delays, etc. (e.g., block 560). The time of these updates can be included as well (e.g., time 564 at block 560, time 570 at block 566, etc.). These updates/decentralized status information can be accessed such that the customer or any other node on the network is notified of the updates.

Milestones and automatic payments for milestones reached (416) can be executed by smart contracts and added to ledger 520 as well. Block 572 can include a generated invoice 574 when a milestone has been reached (576) at time 578 (e.g., when a component has been completed and shipped by a node, which completes a condition of a smart contract that triggers creation of an invoice/payment directed to the node). Block 580 can include that a payment was received (582) at time 584.

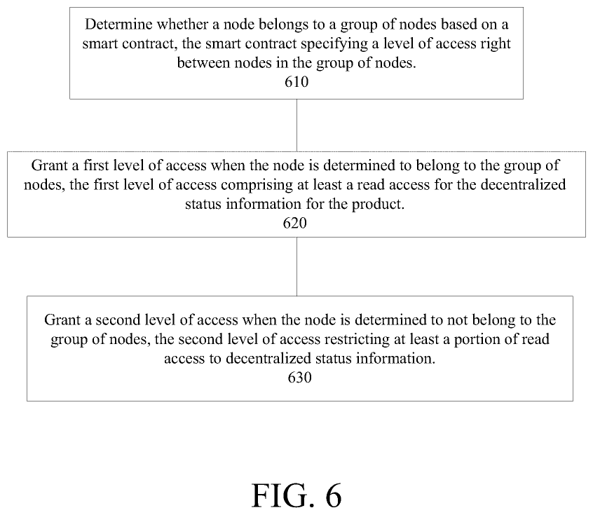

FIG. 6 is a flowchart representation of providing access permissions in a blockchain environment in accordance with some embodiments. For example, the information within the request from the client, and the corresponding action to be taken, can be filtered through the smart contracts, which control the level or type of information that specific nodes on the blockchain can view. For example, the smart contract may split the request into two levels, such that a first level in the message is sensitive customer information (e.g., customer name, ID, etc.) and a second level can specify other information (such as which system is failing, what components need to be replaced, the location of the system, etc.). The method can start by determining whether a node belongs to a group of nodes based on a smart contract (step 610). The smart contract can specify a level of access right between nodes in the group of nodes (step 610). The first level of access right can be granted when the node is determined to belong to the group of nodes, where the first level of access includes at least a read access for the decentralized status information for the product (step 620). The second level of access can be granted when the node is determined to not belong to the group of nodes, where the second level of access can restrict at least a portion of read access to the decentralized status information (step 630). For example, all nodes that belong to a certain group of nodes can read and/or write to the blockchain, while all nodes outside can only read a certain portion of the blockchain that pertains to the group of nodes. As an example, partners (for raw material supplies, component suppliers, configuration, etc.) may be only able to access the second level information in the message, restricting the dissemination of personal or private information not needed for that partner's role in the return process. Any number of levels can be used to customize the level of information access to each node on the blockchain (e.g., a carrier may only be allowed to see customer name and location, for example).

FIG. 7 shows an example schematic diagram of a blockchain network that provides data visualization and analytics in accordance with some embodiments, including access permissions discussed with respect to FIG. 6. FIG. 7 shows an example embodiment where a customer has requested a replacement product that needs to be built or that needs to replace more than one product. All the parties involved in the procurement, build, logistics, and/or even the customer are all enabled as nodes (712, 714, 716, 718, 720, 722) within system 710. In addition to configuring each node to connect to system 710, a predictive analytic algorithm can be added to the node. The predictive tool helps with the computation of data related to the site and its relationship to other site nodes involved in the transaction. For example, the predictive tool is able to understand the relationship between the inventory of the site and the request to provide or manufacture a product coming from a different node. The predictive tool is itself connected to system 710 and can receive business rules and policies from a predictive service 130 that is connected to the replacement managing service 128 and helps with dispatching of the tasks, via events, that each site has to execute.

In these instances, system 710 can generate and monitor the events involved in replacement of the product. Since each node is equipped with a form of intelligence (e.g., smart contracts), that allows it to not only execute different tasks, but also have the awareness of other sites' intelligence to compute many tasks that usually are done in a traditional architecture (by huge amounts of resources, tools, and the exchange of many types of information). For example, when customer interface 724 accesses the replacement management service 128 on their client device, customer interface 724 can get, through the distributed analytics and data visualization 730 on each node, a quick view of, for example, how long it will take to receive a replacement product and be provided the delivery date with a high confidence level. Also, this translates the replacement request into a bill of material and which site/node does what, and then pushes them to system 710 that advertises through the rules and policies of the smart contract what each node can see and execute.

Once the replacement is requested, all the nodes get a copy of events that detail what they need to produce, and each node reports the status in real time in supplier/carrier interface 726 on each supplier or carrier node (e.g., nodes 712, 714, 716, 718, and/or 720). Once the replacement process starts, the customer is given access to monitor the progress (e.g. through customer interface 724 on node 722).

In some embodiments, a consensus of the nodes within system 710 (e.g., whether half or more of the nodes on system 710 agree the transaction is valid) can verify if what was done by a site is valid or not. Also through smart contracts, each site gets paid as soon as the tasks are done.

Moreover, system 710 can have sophisticated interplays between inbound shipments (shipments between different facilities at the same supplier) and outbound shipments (between different suppliers), which can track which replacement components are ready for shipment from inventory or build, and where they are. For example, as components are shipped between certain facilities and suppliers, the RFID of the components can be scanned (and perhaps additional attributes input through manual inspection or other means) to make sure the right components are being shipped where they need to be and at the right time. For example, since system 710 knows which suppliers are involved in building the product, it can flag suppliers for follow up. Moreover, rules and policies specified within smart contracts can automatically and scalably prescribe what steps need to be taken between the suppliers/shippers, and can automatically complete transaction payments as the steps are completed as well as informing the customer of the replacement product's status.

As a result of this information, system 710 can apply predictive analytics to predict when customer interface 724 can expect to receive a completed replacement product, can take unexpected delays and/or component shortages into account, and in some cases can dynamically specify which suppliers are most cost effective for replacing the product. For example, system 710 can sample contextual data on any of the nodes to determine whether a component of a product will be in short supply (e.g., through data tracked by the node, data provided by a third party, etc.). If there will be a component shortage which will affect certain nodes, system 710 can take prescriptive action by ensuring that those nodes will not be used for the build of the product, if needed, or will predict, based on the contextual data, how long the replacement product will be delayed. Moreover, customer interface 724 can in some embodiments specify the nodes, based on information on the blockchain ledger, that they want to be part of the replacement process in order to maximize short turn around, minimize costs, redirect build/shipping to certain localities, etc. In other embodiments, this can be an automated process and different options can be presented to the customer to choose from.

System 710 can also determine that there will be a delay in the replacement of the product based on decentralized status information received from one or more nodes on system 710, and provide a notification of the delay for display to the user on customer interface 724. The delay can be determined based on delays in shipment of the product, such as customs holds or weather delays, reported by one or more nodes on system 710 (either manually or through a third party service).

The blockchain can also have variable levels of security. The level of detail that can be included in the blockchain of system 710 can be, for example, made completely public or can have differing levels of access rights among the customer, the nodes, and/or both. For example, access rights may be restricted to a certain number of nodes, such as the group of nodes that make up a certain supplier (e.g., group 732 including supplier 1 712 and supplier 3 716), but may be restricted partially or entirely from other nodes (e.g., nodes belonging to competing suppliers that shouldn't be able to have any access rights to the first supplier's data, such as supplier 2 714). In the case of competing suppliers having smart contracts between themselves, the blockchain platform may only let the suppliers know if the rules and/or policies have been satisfied, allowing transactional payments to go through while minimizing the share of data. Additionally, a predictive service (e.g., such as predictive service 130 in FIG. 1), can inform about delays, shortages, etc. based on contextual data, which can be used in conjunction with smart contracts to make the smart contracts more flexible (e.g., a smart contract may allow an additional time for a condition to be satisfied, with perhaps lower payment or another condition, instead of taking action for total breach).

A shipping process can also be included in a blockchain for partial or complete read access by a customer. When a customer is in the process of requesting a replacement, for example, the customer can be granted access to the product's associated suppliers and build information on the blockchain. For example, the build information can describe what's in current inventory (the quantity, location, and availability of planned shipments for components of the product), and/or when a completed replacement product is expected to be shipped and/or received by the customer. As the customer views the product(s) to replace, for example, the system can look into the build material to know what's available or what's not currently available in inventory. With this information, the blockchain can tell a customer that they would receive this product in a certain amount of time within a certain confidence, e.g., since the product is in inventory, there is a 90% chance of delivery within 24 hours.

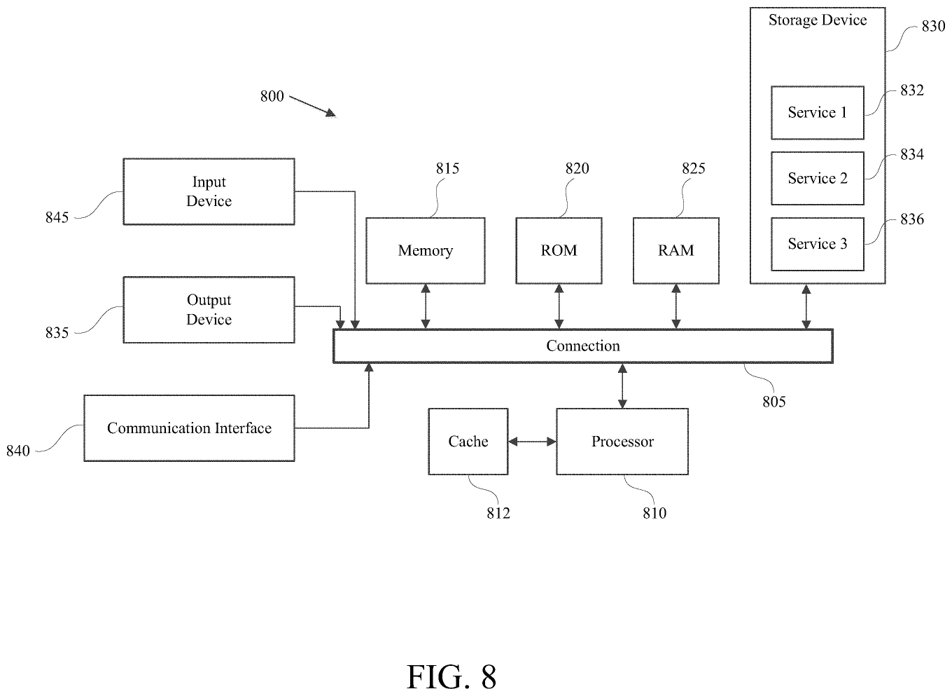

FIG. 8 shows an example of computing system 800 for use in components illustrated in FIGS. 1, 3, 4, 5, and 7, in which the components of the system are in communication with each other using connection 805. Connection 805 can be a physical connection via a bus, or a direct connection into processor 810, such as in a chipset architecture. Connection 805 can also be a virtual connection, networked connection, or logical connection.

In some embodiments computing system 800 is a distributed system in which the functions described in this disclosure can be distributed within a datacenter, multiple datacenters, a peer network, etc. In some embodiments, one or more of the described system components represents many such components each performing some or all of the function for which the component is described. In some embodiments, the components can be physical or virtual devices.

Example system 800 includes at least one processing unit (CPU or processor) 810 and connection 805 that couples various system components including system memory 815, such as read only memory (ROM) and random access memory (RAM) to processor 810. Computing system 800 can include a cache of high-speed memory connected directly with, in close proximity to, or integrated as part of processor 810.

Processor 810 can include any general purpose processor and a hardware service or software service, such as services 832, 834, and 836 stored in storage device 830, configured to control processor 810 as well as a special-purpose processor where software instructions are incorporated into the actual processor design. Processor 810 may essentially be a completely self-contained computing system, containing multiple cores or processors, a bus, memory controller, cache, etc. A multi-core processor may be symmetric or asymmetric.

To enable user interaction, computing system 800 includes an input device 845, which can represent any number of input mechanisms, such as a microphone for speech, a touch-sensitive screen for gesture or graphical input, keyboard, mouse, motion input, speech, etc. Computing system 800 can also include output device 835, which can be one or more of a number of output mechanisms known to those of skill in the art. In some instances, multimodal systems can enable a user to provide multiple types of input/output to communicate with computing system 800. Computing system 800 can include communications interface 840, which can generally govern and manage the user input and system output. There is no restriction on operating on any particular hardware arrangement and therefore the basic features here may easily be substituted for improved hardware or firmware arrangements as they are developed.

Storage device 830 can be a non-volatile memory device and can be a hard disk or other types of computer readable media which can store data that are accessible by a computer, such as magnetic cassettes, flash memory cards, solid state memory devices, digital versatile disks, cartridges, random access memories (RAMs), read only memory (ROM), and/or some combination of these devices.

The storage device 830 can include software services, servers, services, etc., that when the code that defines such software is executed by the processor 810, it causes the system to perform a function. In some embodiments, a hardware service that performs a particular function can include the software component stored in a computer-readable medium in connection with the necessary hardware components, such as processor 810, connection 805, output device 835, etc., to carry out the function.

For clarity of explanation, in some instances the present technology may be presented as including individual functional blocks including functional blocks comprising devices, device components, steps or routines in a method embodied in software, or combinations of hardware and software.

Any of the steps, operations, functions, or processes described herein may be performed or implemented by a combination of hardware and software services or services, alone or in combination with other devices. In some embodiments, a service can be software that resides in memory of a client device and/or one or more servers of a content management system and perform one or more functions when a processor executes the software associated with the service. In some embodiments, a service is a program, or a collection of programs that carry out a specific function. In some embodiments, a service can be considered a server. The memory can be a non-transitory computer-readable medium.

In some embodiments the computer-readable storage devices, mediums, and memories can include a cable or wireless signal containing a bit stream and the like. However, when mentioned, non-transitory computer-readable storage media expressly exclude media such as energy, carrier signals, electromagnetic waves, and signals per se.

Methods according to the above-described examples can be implemented using computer-executable instructions that are stored or otherwise available from computer readable media. Such instructions can comprise, for example, instructions and data which cause or otherwise configure a general purpose computer, special purpose computer, or special purpose processing device to perform a certain function or group of functions. Portions of computer resources used can be accessible over a network. The computer executable instructions may be, for example, binaries, intermediate format instructions such as assembly language, firmware, or source code. Examples of computer-readable media that may be used to store instructions, information used, and/or information created during methods according to described examples include magnetic or optical disks, solid state memory devices, flash memory, USB devices provided with non-volatile memory, networked storage devices, and so on.

Devices implementing methods according to these disclosures can comprise hardware, firmware and/or software, and can take any of a variety of form factors. Typical examples of such form factors include servers, laptops, smart phones, small form factor personal computers, personal digital assistants, and so on. Functionality described herein also can be embodied in peripherals or add-in cards. Such functionality can also be implemented on a circuit board among different chips or different processes executing in a single device, by way of further example.

The instructions, media for conveying such instructions, computing resources for executing them, and other structures for supporting such computing resources are means for providing the functions described in these disclosures.

Although a variety of examples and other information was used to explain aspects within the scope of the appended claims, no limitation of the claims should be implied based on particular features or arrangements in such examples, as one of ordinary skill would be able to use these examples to derive a wide variety of implementations. Further and although some subject matter may have been described in language specific to examples of structural features and/or method steps, it is to be understood that the subject matter defined in the appended claims is not necessarily limited to these described features or acts. For example, such functionality can be distributed differently or performed in components other than those identified herein. Rather, the described features and steps are disclosed as examples of components of systems and methods within the scope of the appended claims.

What is claimed is:

1. A method comprising:
receiving a request from a user to perform maintenance on a product;
creating an event in accordance with a rule or policy of a smart contract, the event based on node supply chain relationships specified within the smart contract;
sending the event to a node on a distributed network, the event based on at least one condition that is in accordance with fulfilling the rule or policy of the smart contract, wherein the node is configured to automatically execute the condition;
updating decentralized status information for the product when the event has been fulfilled; and
granting at least read access to the decentralized status information of the product to at least one node on the distributed network.

2. The method of claim 1, wherein the request from the user further comprises an option to ship a replacement of the product, and the option enables the distributed network to automatically generate a set of tasks for the node to replace the product based on the at least one condition of the smart contract.

3. The method of claim 1, wherein the node is one or more of suppliers or partners in a supply distribution chain of the product, and the node automatically self-executes the condition.

4. The method of claim 1, further comprising:
granting at least read access to the decentralized status information of the product to the user; and
displaying a prediction of completion of the request determined by node supply chain relationships specified within the smart contract.

5. The method of claim 1, further comprising:
determining whether the node belongs to a group of nodes based on the smart contract, the smart contract specifying a level of access right between nodes in the group of nodes;
granting a first level of access when the node is determined to belong to the group of nodes, the first level of access comprising at least a read access for the decentralized status information for the product; and
granting a second level of access when the node is determined to not belong to the group of nodes, the second level of access restricting at least a portion of read access to the decentralized status information.

6. The method of claim 1, wherein the event comprises real time updates for one or more of building the product, assembling the product, shipping the product, or exchanging payments between one or more suppliers or partners.

7. The method of claim 1, wherein the creation of the event is based on historical ledger history information.

8. A non-transitory computer-readable medium comprising instructions stored thereon, the instructions executable by one or more processors of a computing system to perform a method for dynamically requesting a network resource, the instructions causing the computing system to:
receive a request from a user to perform maintenance on a product;
create an event in accordance with a rule or policy of a smart contract, the event based on node supply chain relationships specified within the smart contract;
send the event to a node on a distributed network, the event based on at least one condition that is in accordance with fulfilling the rule or policy of the smart contract, wherein the node is configured to automatically execute the condition;
update decentralized status information for the product when the event has been fulfilled; and
grant at least read access to the decentralized status information of the product to at least one node on the distributed network.

9. The non-transitory computer-readable medium of claim 8, wherein the request from the user further comprises an option to ship a replacement of the product, and the option enables the distributed network to automatically generate a set of tasks for the node to replace the product based on the at least one condition of the smart contract.

10. The non-transitory computer-readable medium of claim 8, wherein the node is one or more of suppliers or partners in a supply distribution chain of the product, and the node automatically self-executes the condition.

11. The non-transitory computer-readable medium of claim 8, the instructions causing the computing system to further:
grant at least read access to the decentralized status information of the product to the user; and
display a prediction of completion of the request determined by node supply chain relationships specified within the smart contract.

12. The non-transitory computer-readable medium of claim 8, the instructions causing the computing system to further:
determine whether the node belongs to a group of nodes based on the smart contract, the smart contract specifying a level of access right between nodes in the group of nodes;
grant a first level of access when the node is determined to belong to the group of nodes, the first level of access comprising at least a read access for the decentralized status information for the product; and
grant a second level of access when the node is determined to not belong to the group of nodes, the second level of access restricting at least a portion of read access to the decentralized status information.

13. The non-transitory computer-readable medium of claim 8, wherein the event comprises real time updates for one or more of building the product, assembling the product, shipping the product, or exchanging payments between one or more suppliers or partners.

14. The non-transitory computer-readable medium of claim 8, wherein the creation of the event is based on historical ledger history information.

15. A system comprising:
a network device comprising a node on a distributed network, the network comprised of a plurality of nodes, wherein the network device:
receives a request from a user to perform maintenance on a product;
creates an event in accordance with a rule or policy of a smart contract, the event based on node supply chain relationships specified within the smart contract;
sends the event to a node on a distributed network, the event based on at least one condition that is in accordance with fulfilling the rule or policy of the smart contract, wherein the node is configured to automatically execute the condition;
updates decentralized status information for the product when the event has been fulfilled; and
grants at least read access to the decentralized status information of the product to at least one node on the distributed network.

16. The system of claim 15, the request from the user further comprises an option to ship a replacement of the product, and the option enables the distributed network to automatically generate a set of tasks for the node to replace the product based on the at least one condition of the smart contract.

17. The system of claim 15, wherein the node is one or more of suppliers or partners in a supply distribution chain of the product, and the node automatically self-executes the condition.

18. The system of claim 15, wherein the network device further:
grants at least read access to the decentralized status information of the product to the user; and
displays a prediction of completion of the request determined by node supply chain relationships specified within the smart contract.

19. The system of claim 15, wherein the network device further:
determines whether the node belongs to a group of nodes based on the smart contract, the smart contract specifying a level of access right between nodes in the group of nodes;
grants a first level of access when the node is determined to belong to the group of nodes, the first level of access comprising at least a read access for the decentralized status information for the product; and
grants a second level of access when the node is determined to not belong to the group of nodes, the second level of access restricting at least a portion of read access to the decentralized status information.

20. The system of claim 15, wherein the event comprises real time updates for one or more of building the product, assembling the product, shipping the product, or exchanging payments between one or more suppliers or partners.
